(19) United States
(12) Patent Application Publication
(10) Pub. No.: US 2020/0217285 A1
(43) Pub. Date: Jul. 9, 2020

(54) DEVICE FOR THE ELECTRICAL CONNECTION OF A CONTROL CABLE TO A PLURALITY OF INJECTION VALVES

(71) Applicant: Robert Bosch GmbH, Stuttgart (DE)

(72) Inventor: Marc Spinner, Sindelfingen (DE)

(21) Appl. No.: 16/733,438

(22) Filed: Jan. 3, 2020

(30) Foreign Application Priority Data
Jan. 4, 2019 (DE) 102019200037.1

(51) Int. Cl. F02M 51/06; F02D 41/30; H01R 24/64

(52) U.S. Cl. CPC F02M 51/061; H01R 24/64; F02D 41/3005

(57) ABSTRACT

A device that is used for the electrical connection of a control cable to a plurality of injection valves includes a connecting plug to which the control cable can be plugged, and a plurality of contact points at each of which an electrical connection to one of the injection valves is enabled. Electrical lines are routed from the connecting plug to the contact points, and, at least in come segments the routing is through a housing. The connecting plug has a connecting plug receptacle and a plug element that, in the installed state, is plugged into the connecting plug receptacle and that receives ends of the electrical lines.

### CROSS-REFERENCE TO RELATED APPLICATIONS

The present application claims priority under 35 U.S.C. § 119 to DE 10 2019 200 037.1 filed in the Federal Republic of Germany on Jan. 4, 2019, the content of which is hereby incorporated by reference herein in its entirety.

### FIELD OF THE INVENTION

The present invention relates to a device for the electrical connection of a control cable to a plurality of injection valves. Specifically, the present invention relates to injectors for fuel injection systems of motor vehicles in which a direct injection of fuel into combustion chambers of an internal combustion engine preferably takes place.

### BACKGROUND

From DE 43 25 980 A1, a device is known for the common electrical contacting of a plurality of fuel injection valves of a fuel injection system of internal combustion engines. The known device has a circuit board and a housing that protects the circuit board. On the fuel injection valves, contact pins are provided via which the fuel injection valves are connected immediately to conductor paths of the circuit board. Here, problems can arise at a connection plug installed on the circuit board. These problems relate to the resistance to vibration of the connections between pins of the connection plug and the conductor paths, sealings that are required for the circuit board, and electromagnetic compatibility at high electrical currents. In addition, costly production steps, such as soldering, welding, or screwing, are required in order to realize the connections to the conductor paths.

### SUMMARY

Example embodiments of the present invention provide a device with an improved design and function that enables simplified installation.

A device according to an example embodiment of the present invention is used for an electrical connection of a control cable to a plurality of injection valves. The control cable and/or a control cable plug for the control cable are not necessarily components of the device according to the present invention. In addition, the injection valves are not necessarily components of the device according to the present invention. In particular, the device can also be produced and marketed independently of a control cable and the injection valves.

Depending on the realization of the device, disadvantages with regard to construction and costs can be avoided. For example, additional mounts can be saved. For example, in an example embodiment, no additional fastening for a connecting plug to a cylinder head is required. In addition, additional fasteners, used to fasten the electrical lines to a cylinder head, can be saved. In addition, the installation process can be improved. In particular, a long free length of cable, which can hinder the installation of the fuel injection system and would be cumbersome during transport, can be avoided. The proposed device enables the electrical contacting to the control cable, which can be a component of the engine cable harness, directly at the connecting plug, which can be formed on the housing. Specifically, the housing can be produced in an injection molding process, such that the plug interface can be partly integrated into the housing and therefore can be made from the same material.

The electrical contacting to the control cable plug of the control cable can be realized with electrically conductive connecting elements clipped into a connecting plug receptacle, preferably produced in an injection molding process.

In an example embodiment, the connecting plug receptacle is fashioned such that a control cable plug for the control cable can be plugged to the connecting plug receptacle in order to produce a detachable mechanical connection, electrical connections being formed between the electrical lines and the control cable in an installed state. This can provide an advantage that the control cable plug can be fastened directly to the connecting plug receptacle. In this way, further interfaces are avoided.

In an example embodiment, a plug element has receptacle bores through each of which an end of the electrical lines is guided. Through-openings are fashioned on the connecting plug receptacle, and the ends of the electrical lines guided through the receptacle bores of the plug element are, in the installed state, fixed in the through-openings of the connecting plug receptacle. This can provide an advantage that a reliable fastening of the ends of the electrical lines in the installed state is ensured. This development is easy to install because no complex installation processes such as soldering, welding, or screwing are required. In addition, a high degree of mechanical strength against vibrations during operation and the like is provided. In addition, an advantageous mechanical protection results. Moreover, a reliable sealing can easily be realized when the control cable plug is fastened to the connecting plug receptacle.

In an example embodiment, a line guide is provided through which the electrical lines are guided at least in segments. The line guide has a plurality of arms that guide the electrical lines assigned to respective contact points to the respective contact points. In an example, at least one arm of the line guide is led out from a housing. This arrangement provides for routing the electrical lines through the housing and to the individual fuel injection valves. Here, the arms of the line guide advantageously have a certain degree of mechanical flexibility in order to simplify installation. The points of contact to the injection valves can be realized here via valve plugs of the device. The valve plugs can then easily be plugged onto the injection valves, significantly simplifying installation. Flexible arms of the line guide facilitate installation. At the same time, a reliable protection of the electrical lines is ensured by the arms of the line guide.

Advantageously, the housing is realized having multiple parts. A two-part realization is particularly advantageous. In an example, the housing has a receptacle part and a housing cover that, in the installed state, is connected to the receptacle part, and a connecting plug receptacle is formed on the receptacle part. This arrangement enables particularly good ease of installation.

In an example embodiment, fastening arms are provided on the housing and are used to fasten the housing to a fuel distributor, where, in the installed state, the fastening arms surround, at least in segments, a pipe-shaped basic body of the fuel distributor. In particular, the fastening arms can be provided on the receptacle part of the housing.

Preferred example embodiments of the present invention are explained in more detail in the following description with reference to the accompanying drawings in which corresponding elements are provided with the same reference characters.

### BRIEF DESCRIPTION OF THE DRAWINGS

FIG. 1 shows a device in a schematic, spatial representation according to a first example embodiment of the present invention.

FIG. 2 shows the device of FIG. 1, in an open, detailed representation, according to an example embodiment of the present invention.

FIG. 3 shows a device in a schematic, spatial representation according to a second example embodiment of the present invention.

FIG. 4 shows the device of FIG. 3 in an open, detailed representation, according to an example embodiment of the present invention.

FIG. 5 shows a detail of the device of FIG. 3, in a detailed sectional representation, according to an example embodiment of the present invention.

FIG. 6 shows detail corresponding to FIG. 5 in an installed state, according to an example embodiment of the present invention.

### DETAILED DESCRIPTION

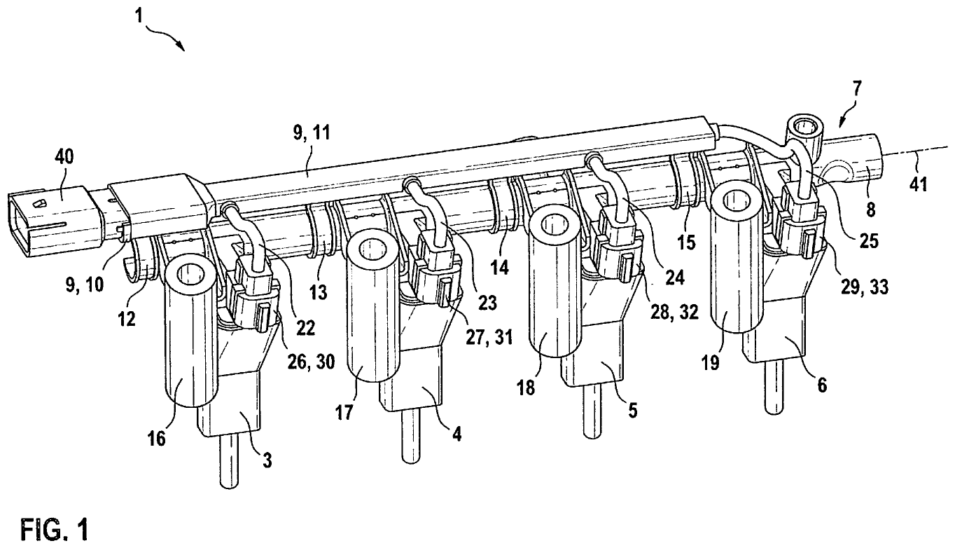

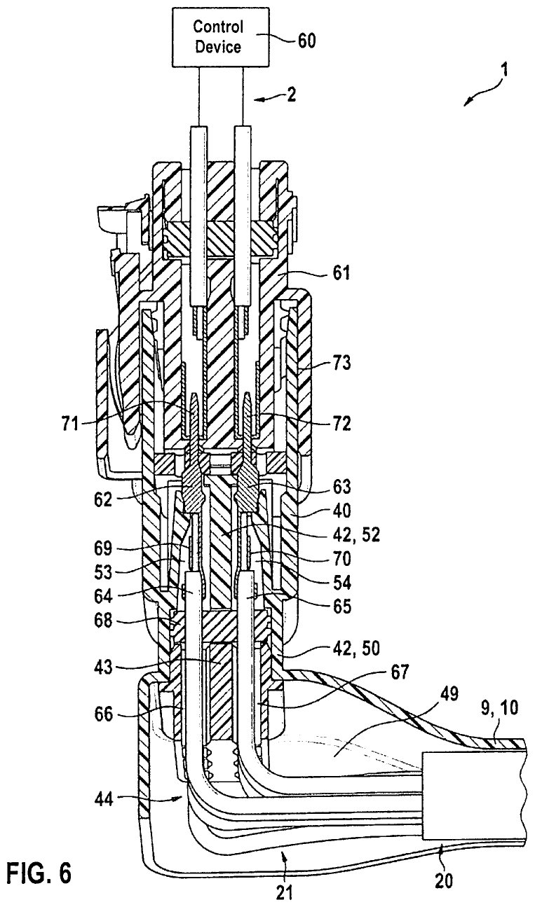

FIG. 1 shows a device 1 in a schematic, spatial representation, corresponding to a first example embodiment. Device 1 is used for the electrical connection of a control cable 2 (FIG. 6), which can for example be a component of an engine cable harness, to a plurality of fuel injection valves 3, 4, 5, 6 (shown schematically) of an internal combustion engine. A fuel distributor 7, having a pipe-shaped basic body 8, is fastened to a cylinder head of an internal combustion engine. Device 1 is in turn fastened to pipe-shaped basic body 8 of fuel distributor 7.

Device 1 has a multi-part housing 9 having a receptacle part 10 and a housing cover 11. Housing 9 can be made for example in an injection molding process.

On receptacle part 10, a plurality of fastening arms 12-15 are provided that enclose pipe-shaped basic body 8 in some segments. Fastening arms 12-15 can be fashioned such that receptacle part 10, with fastening arms 12-15, can be clipped laterally onto pipe-shaped basic body 8. In the assembled state, housing cover 11 is connected to receptacle part 10, as is shown in FIG. 1. In addition, mounts 16-19 are provided for fastening (screwing) device 1 onto, for example, an engine or cylinder head.

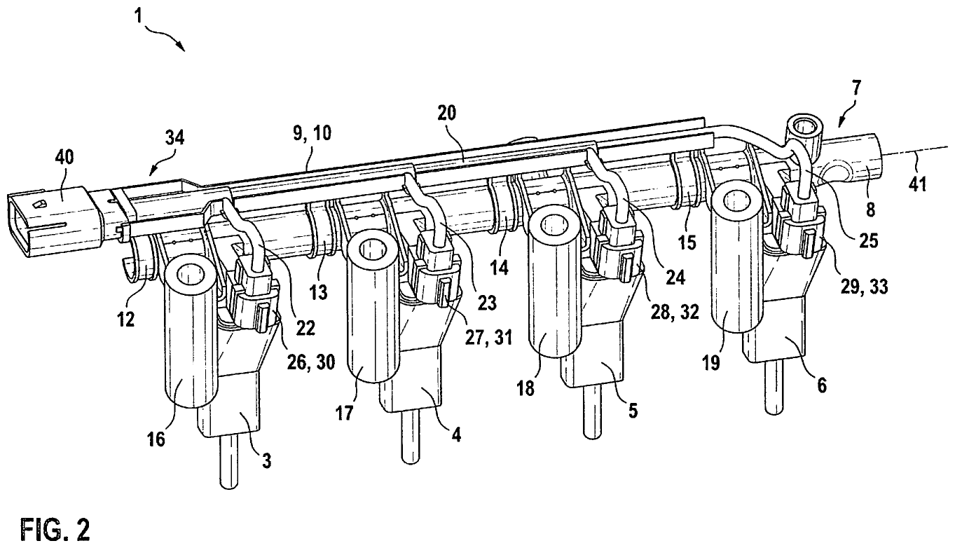

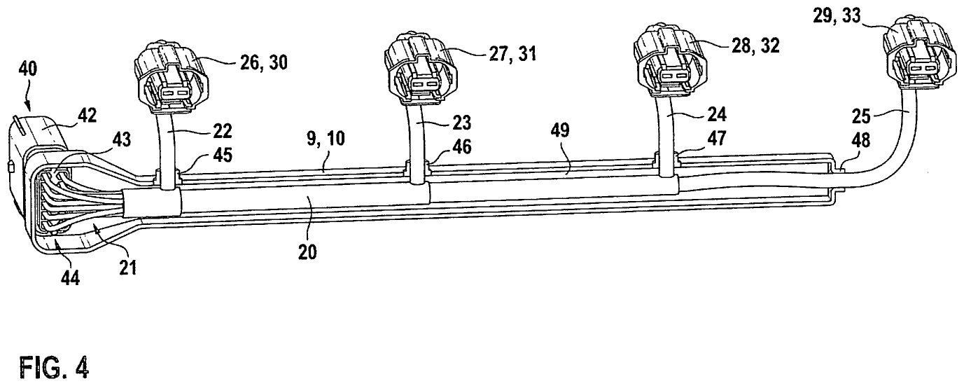

Device 1, in the first example embodiment, is further described below with reference to FIG. 2, which shows device 1 of FIG. 1 in an open, detailed representation. Here, housing cover 11 is removed. In receptacle part 10 there is situated a line guide 20 through which electrical lines 21 (FIG. 4) are routed. During installation, line guide 20 can be placed into receptacle part 10 together with the electrical lines routed through this guide.

Line guide 20 has arms 22-25, the electrical lines 21 assigned to the respective fuel injection valve 3-6 being guided to contact points 26-29 by each arm. Contact points 26-29 are realized by valve plugs 30-33 in this example embodiment. Arms 22-25 are led out from housing 9. A certain degree of flexibility of arms 22-25 enables easy installation of valve plugs 30-33 on fuel injection valves 3-6. In addition, there results a reliable protection of electrical lines 21.

In a region 34, electrical lines 21 are connected to a connecting plug 40. For the description in this regard, reference is made to FIG. 4, on the basis of which a corresponding embodiment is realized.

In this example embodiment, connecting plug 40 is oriented parallel to a longitudinal axis 41 of pipe-shaped basic body 8 of fuel distributor 7.

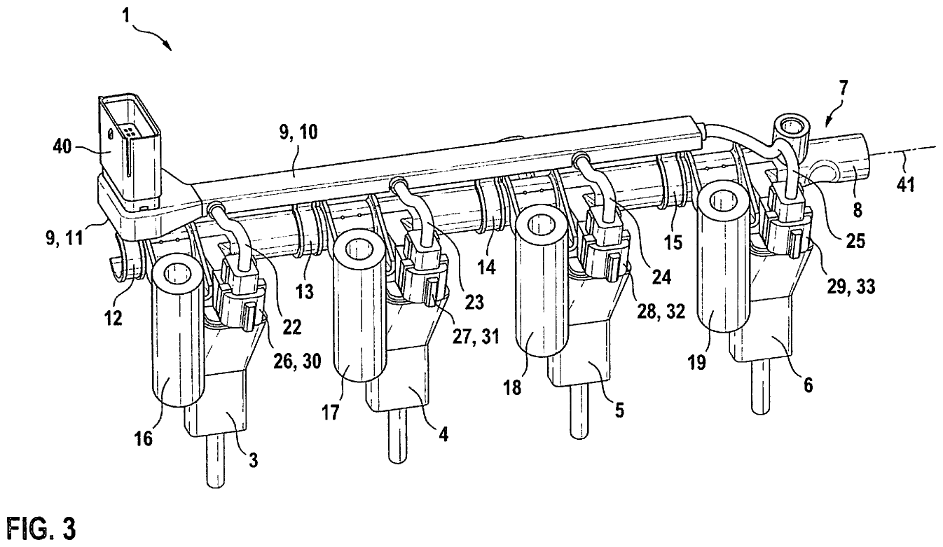

FIG. 3 shows device 1 in a schematic, spatial representation, corresponding to a second example embodiment. In this example embodiment, connecting plug 40 is oriented perpendicular to longitudinal axis 41 of pipe-shaped basic body 8 of fuel distributor 7. In addition, FIG. 4 shows device 1, shown in FIG. 3, in an open, detailed representation. In this example embodiment, housing cover 11 is oriented towards pipe-shaped basic body 8.

Therefore, fastening arms 12-15 can be provided on housing cover 11 in this example embodiment.

Connection plug 40 has a connection plug receptacle 42 formed on receptacle part 10 of housing 9. In addition, connecting plug 40 has a plug element 43 through which ends 44 of electrical lines 21 are routed. Electrical lines 21 are then routed by line guide 20 from connecting plug 40 to valve plugs 30-33. Collars 45-48 are formed on receptacle part 10, which on the one hand fix arms 22-25 and on the other hand ensure a sealing of an internal compartment 49 of housing 9.

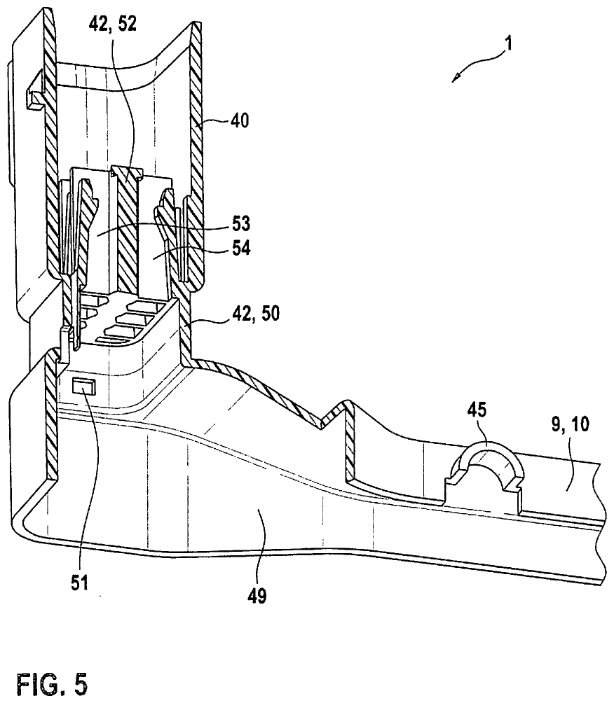

FIG. 5 shows a detail of device 1 shown in FIG. 3, in a detailed sectional representation corresponding to the second example embodiment. Connecting plug 40 has connecting plug receptacle 42, and, in the installed state, plug element 43 is inserted into a receptacle part 50 of connecting plug receptacle 42. One or more openings 51 can be provided on receptacle part 50 of connecting plug receptacle 42, in which plug element 43 engages. Connecting plug receptacle 42 also has a connecting part 52 in which a plurality of through-openings 53, 54 are made. To simplify the representation, only through-openings 53, 54 are identified.

In the following, the design of device 1 is further described with reference to FIG. 6, which shows the detail of device 1 shown in FIG. 5 in the installed state. In addition, a control device 60 is schematically shown from which control cable 2 is guided to device 1. A control cable plug 61, provided on control cable 2, is plugged onto connecting plug 40 in the installed state. Electrically conductive connecting elements 62, 63 are placed into connecting part 52 of connecting plug receptacle 42. FIG. 6 shows connecting elements 62, 63 situated in through-openings 53, 54, the number of electrically conductive connecting elements corresponding to the number of electrical lines 21.

Of the ends 44 of electrical lines 21, in FIG. 6 two ends 64, 65 are identified as examples and shown in detail. Ends 64, 65 of electrical lines 21 are routed through receptacle bores 66, 67 of plug element 43. For the sealing, an intermediate element 68 can also be provided through which ends 64, 65 also extend before they are clamped between contact tongues 69, 70 of connecting elements 62, 63. At contact tongues 69, 70, the clamping effect produces an electrical contact, so that via pins 71, 72 of electrically conductive connecting elements 62, 63, an electrical connection to control cable 2 is enabled via control cable plug 61.

In the installed state, ends 64, 65 are thus reliably fixed. The installation can take place without costly connecting methods such as welding, soldering, or screwing.

Moreover, a high degree of mechanical strength is achieved of the detachable mechanical connection 73 between connecting plug 40 and control cable plug 61, at the same time ensuring a seal in the installed state.

In addition, in this example embodiment, connecting plug receptacle 42 is fashioned such that electrically conductive connecting elements 62, 63 can easily be clipped into connecting part 52.

Depending on the embodiment of device 1, this results in significant advantages. Device 1 can be constructively adapted to any fuel distributors 7 and to the installation space available at the engine. In particular, if housing 9 is produced by injection molding, a large number of variant embodiments are enabled at low production cost. Independent of the configuration of contact points 26-29, almost any configurations and orientations of connecting plug 40 can be enabled, an axial orientation and a radial orientation being illustrated on the basis of the described example embodiment. Electrical lines 21 can carry the signals for controlling fuel injection valves 3-6. In addition, it is also possible for a part of electrical lines 21 to be used for the contacting of sensors, in particular a pressure sensor, a temperature sensor, and/or a knock sensor. Due to line guide 20, with arms 22-25, there results a positionally accurate guiding of electrical lines 21 and a precise positioning of valve plugs 30-33. As a result, additional mounting or fastening elements can be omitted. In addition, there are no freely suspended electrical lines. Moreover, an advantageous pre-assembly can take place, which is easy to handle, transport, and pack. The final installation is also significantly simplified because, for example, installation steps such as pre-placement on specific assembly boards are omitted.

The present invention is not limited to the described example embodiments.

What is claimed is:

1. A device for the electrical connection of a control cable to a plurality of injection valves, the device comprising:
a housing;
a plurality of contact points via each of which an electrical connection of a respective one of the plurality of injection valves is enabled;
electrical lines routed, at least partly through the housing, from the connecting plug to the contact points; and
a connecting plug to which the control cable is pluggable and that includes:
a connecting plug receptacle; and
an electrical line receiver that, in an installed state, is plugged into the connecting plug receptacle and that receive ends of the electrical lines.

2. The device of claim 1, wherein the connecting plug receptacle is formed on the housing.

3. The device of claim 1, further comprising electrically conductive connectors that are fastened to the connecting plug receptacle and that, in the installed state, enable electrical connections between the ends of the electrical lines and the control cable.

4. The device of claim 1, further comprising electrically conductive connectors that are clipped to the connecting plug receptacle and that, in the installed state, enable electrical connections between the ends of the electrical lines and the control cable.

5. The device of claim 1, wherein a control cable plug for the control cable is pluggable to the connecting plug receptacle to produce a detachable mechanical connection by which electrical connections are formed between the electrical lines and the control cable in the installed state.

6. The device of claim 1, wherein:
the connecting plug receptacle includes through-openings; and
the electrical line receiver has receptacle bores through each of which is guided a respective end of one or more of the electrical lines, which, in the installed state, is fixed in a respective one of the through-openings.

7. The device of claim 1, further comprising a line guide through which at least one or more sections of the electrical lines are guided.

8. The device of claim 7, wherein the line guide includes a plurality of arms that each guides a respective one of the electrical lines to a respective one of the contact points.

9. The device of claim 8, wherein at least one of the arms of the line guide extends out from the housing.

10. The device of claim 1, wherein the housing includes:
a receptacle on which the connecting plug receptacle is formed; and
a cover that, in the installed state, is connected to the receptacle.

11. The device of claim 1, further comprising fastening arms that are positioned on the housing, and that, in the installed state surround sections of a pipe-shaped basic body of a fuel distributor, thereby fastening the housing to the fuel distributor.
